(19) United States
(12) Patent Application Publication
(10) Pub. No.: US 2004/0163211 A1
(43) Pub. Date: Aug. 26, 2004

(54) Hinge

(76) Inventor: Marco Rucker, Hohenems (AT)

Correspondence Address: WENDEROTH, LIND & PONACK, L.L.P., 2033 K STREET N. W., SUITE 800, WASHINGTON, DC, 20006-1021, US

(21) Appl. No.: 10/392,900

(22) Filed: Mar. 21, 2003

(30) Foreign Application Priority Data
Feb. 21, 2003 (AT) GM 109/2003

(51) Int. Cl. E05D 7/04

(52) U.S. Cl. 16/235

(57) ABSTRACT

A hinge (2), preferably a single-axle hinge, for furniture with a frame (3) and with a door wing (1) secured to the frame (3). The hinge (2) has a bedplate (5) which is to be fitted to the frame (3) and which carries a hinge arm (7). A joint-adjustment screw (24) is provided and furthermore a diagonal guide for the hinge arm (7), via which the latter is also shifted upon turning of the joint-adjustment screw (24) relative to the bedplate (5) in the direction of the depth of the item of furniture.

### BACKGROUND OF THE INVENTION

The invention relates to a hinge, preferably a single-axle hinge, for furniture with a frame and with a door wing secured to the frame, with a bedplate which is to be fitted to the frame and which carries a hinge arm, and with a joint-adjustment screw.

In modern furniture construction, so-called door frames are sometimes used, these frames, as a stable part of the item of furniture, carrying the hinges for the door wings, while the actual side walls of the body of the furniture are made from weaker material. This brings with it the advantage that either the overall costs of the item of furniture can be reduced, or higher-quality and thus optically more attractive materials can be chosen for the side walls without the item of furniture being more expensive compared with furniture produced by conventional means.

Such a hinge is known for example from the Austrian utility model AT 1385 U1.

With such hinges, an adjustment possibility is provided for the position of the hinge axle relative to the bedplate in the direction of the furniture joint, i.e. perpendicular to the side wall of the item of furniture. This adjustment is achieved through the joint-adjustment screw which is housed in a nut thread of the hinge arm and is held with its head in a recess of the bedplate or of an intermediate piece.

It has proved disadvantageous that during a side setting of the door, i.e. during the joint adjustment, the hinge arm is swivelled through turning of the joint-adjustment screw. A lateral adjustment of the hinge arm relative to the side wall of the furniture can therefore result in the door either being raised too far from the front of the frame or sticking to it. With the known hinges it is therefore necessary, after every side adjustment (joint adjustment) of the door, to adjust the position of the hinge arm on the bedplate in the direction of the depth of the item of furniture. Such a position adjustment is laborious and relatively time-consuming.

### SUMMARY OF THE INVENTION

The object of the invention is to improve a hinge of the type mentioned at the outset such that an adjustment of the position of the door wing in the direction of the furniture joint does not change the position of the door wing in the direction of the depth of the item of furniture.

The object according to the invention is achieved by a diagonal guide for the hinge arm via which the latter, upon turning of the joint-adjustment screw relative to the bedplate, is also shifted in the direction of the depth of the item of furniture.

It is advantageously provided that the diagonal guide is formed by grooves or slits in side bars of the bedplate, into which guide journals of the hinge arm project.

In order that, with such a hinge, there is the possibility of a depth adjustment independent of the joint adjustment, it is provided in another embodiment of the invention that at least one intermediate piece, at which the grooves or slits are developed and the guide journals are housed, is arranged between the bedplate and the hinge arm.

An advantageous variant of this embodiment provides that two intermediate pieces are arranged between the hinge arm and the bedplate and the diagonal guide is developed between these two intermediate pieces.

### BRIEF DESCRIPTION OF THE DRAWINGS

Various embodiments of the invention are described below with reference to the figures of the attached drawings. There are shown in:

FIG. 1 a perspective view of a hinge according to the invention in the mounting position, wherein sections of the frame and of the door wing are shown,

FIG. 2 an exploded perspective view of a hinge,

FIGS. 3, 4 and 5 side views of a hinge according to the invention, partly in section, with different positions of the hinge arm,

FIG. 6 a perspective view of another embodiment of a hinge according to the invention,

FIG. 7 a top view of a hinge according to FIG. 6,

FIG. 8 a side view of a hinge according to FIG. 6, and

FIG. 9 an exploded perspective view of a hinge according to the embodiment of FIGS. 6 to 8.

### DETAILED DESCRIPTION OF THE PREFERRED EMBODIMENTS

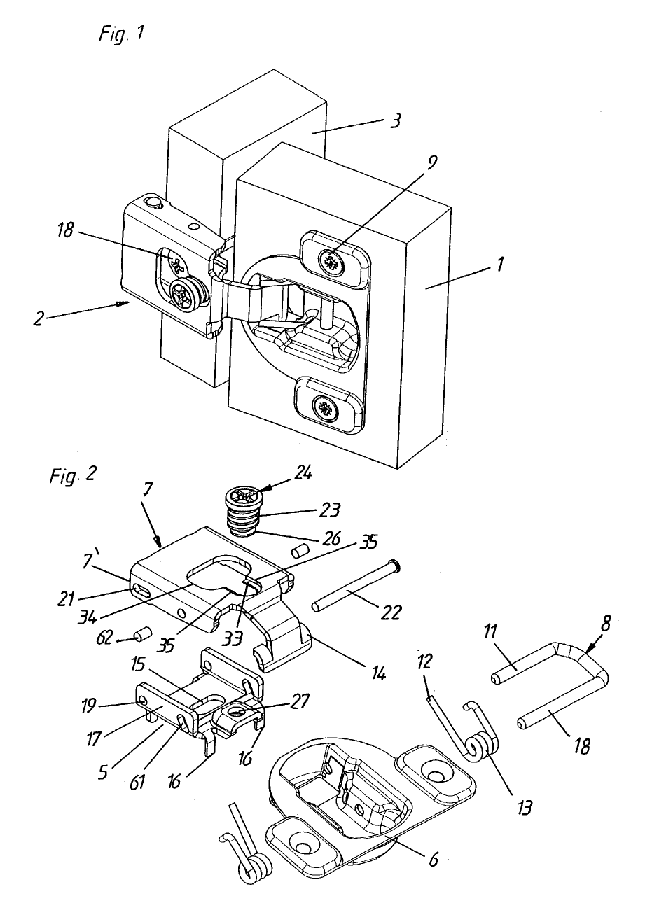

In FIG. 1, the door wing 1 is shown in the open position. The hinge 2 connects the door wing 1 to the frame 3 of the body of the item of furniture.

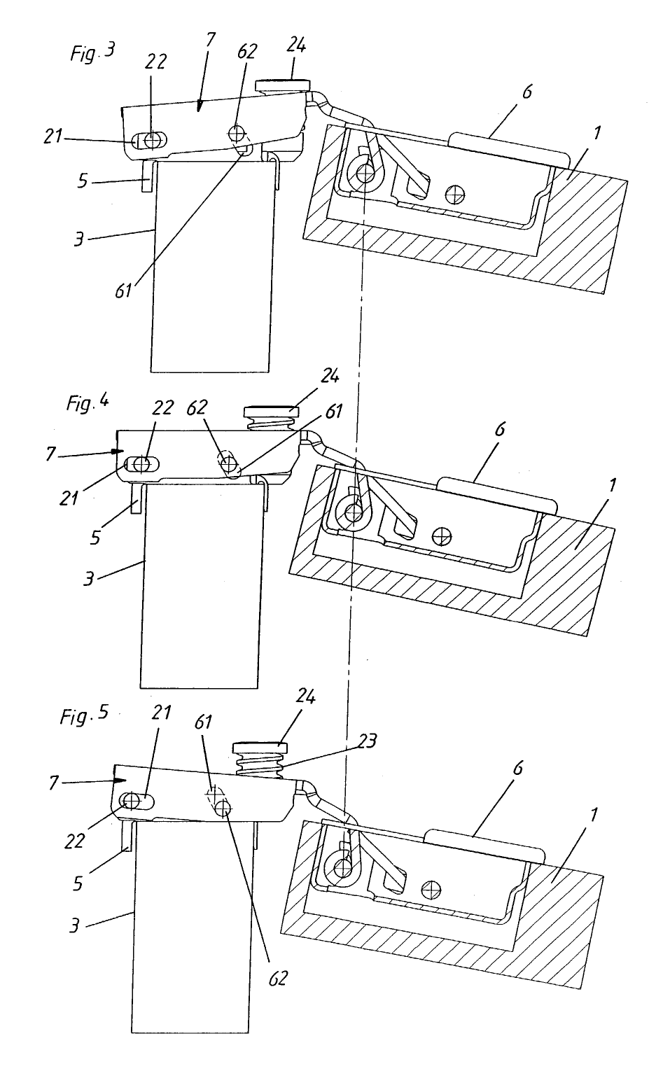

In the embodiment according to FIGS. 1 to 5, the hinge 2 consists of the bedplate 5, the hinge arm 7 and the hinge casing 6 on the door wing side. The hinge casing 6 is articulated to the hinge arm 7 by means of a hinge axle. The hinge axle is formed by one leg 11 of a U-stirrup 8.

The hinge casing 6 is inserted into a bore in the door wing 1 in mounting position and screwed to the door wing 1 by means of screws 9.

Two legged springs 13, which exert a closure force, are housed at the hinge casing 6. The legged springs 13 are housed on the second leg 18 of the U-stirrup 8.

The legs 12 of the legged springs 13 press on a control part 14 which is developed at the free end of the hinge arm 7. The hinge casing 6 is held in the closure position by the legged springs 13, or pulled into the closure position if the angle between the door wing 1 and the closure plane is very small.

The bedplate 5 is housed directly against the frame 3 and is screwed to the frame 3 by means of a fixing screw 18 which projects through an oblong hole 15 of the bedplate 5. On the side facing the open door wing 1, the bedplate 5 has two angled lugs 16 which rest against the frame 3 at the front in mounting position.

At the rear of the frame 3, the bedplate 5 is also provided with a lug which rests against the frame 3 at the rear.

The hinge arm 7 is developed with U-shaped cross-section. The bedplate 5 has two side legs 17 which project into the profile of the hinge arm 7. The side bars 7′ of the hinge arm 7 point towards the bedplate 5. The upwardly bent butts 17 of the bedplate 5 are provided with holes 19 which are designed as bores or punched holes. The side bars 7′ of the hinge arm 7 have oblong holes 21. The hinge arm 7 is connected to the bedplate 5 by means of a pin 22 which projects through the holes 19, 21.

If the position of the door wing 1 is to be adjusted in the direction of the furniture joint, the joint-adjustment screw 24 is turned and thus the hinge arm 7 is tilted about the pin 22.

The joint-adjustment screw 24 has a threaded section 23, a neck and a head 26. The bedplate 5 is provided with a hole 27, through which the neck of the joint-adjustment screw 24 projects which is riveted with its head 26 to the bedplate 5. The hinge arm 7 has an oblong hole 33, open to the rear, which opens out in a further oblong hole 34. The oblong holes 33 and 34 together form a keyhole.

The opposite-facing rims 35 of the oblong hole 33 engage in the thread of the threaded section 23 of the joint-adjustment screw 24. In order to facilitate this engagement, the rims 35 are offset in the direction of the length of the joint-adjustment screw 24 over the height of a thread pitch. The oblong hole 34 in the hinge arm 7 makes possible the suspension of the joint-adjustment screw 24 into the oblong hole 33. The oblong hole 34 also allows access of an adjustment tool to the fixing screw 18. If the fixing screw 18 is loosened, the position of the hinge 2 in the direction of the height of the item of furniture can be adjusted over the length of the oblong hole 15.

In order that, during the joint adjustment of the hinge arm, the position of the hinge axle is not also changed in the direction of the depth of the item of furniture, the bedplate 5 has grooves 61, running diagonally in its side bars 17, in which journals 62 housed in the side bars 7′ of the hinge arm 7 engage. Through the diagonal guide of the grooves 61 and the journals 62, upon turning of the adjustment screw 24 the hinge arm 7 is automatically simultaneously shifted in the direction of the depth of the item of furniture, as a result of which the swivelling of the hinge axis during the joint adjustment is again balanced out. This movement is made possible by the oblong holes 21.

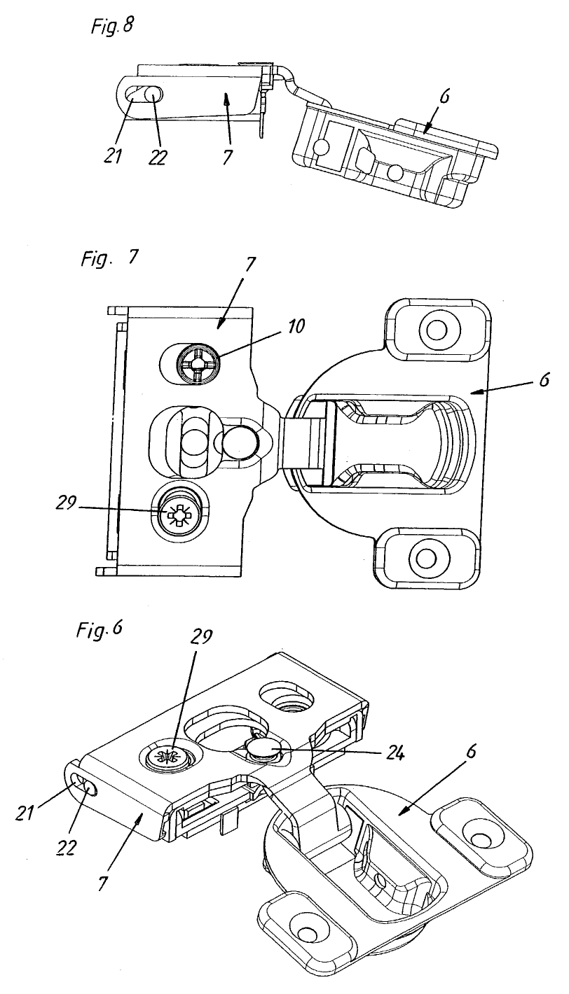

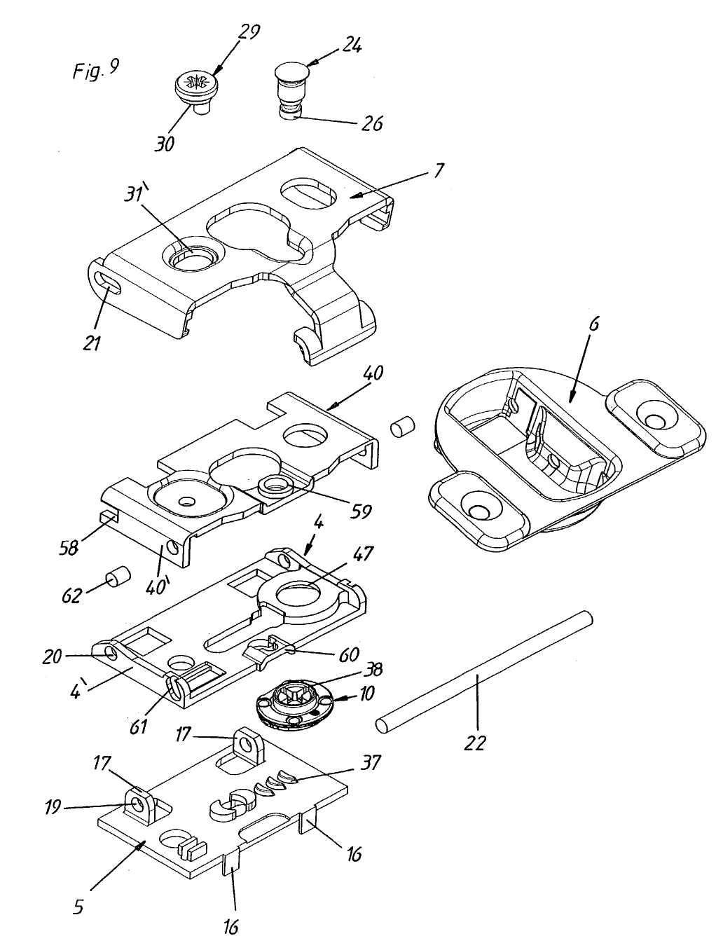

In the embodiment according to FIGS. 6 to 9, the hinge 2 has two intermediate pieces 4 and 40.

The bedplate 5, the intermediate piece 4, the intermediate piece 40 and the hinge arm 7 are articulated to each other by a pin 22. The pin 22 projects through oblong holes 21 in the hinge arm 7, slits 58, open to the rear, in the intermediate piece 40, circular holes 20 in the side bars 4′ of the intermediate piece 4 and circular holes 59 in the upwardly bent butts 17 of the bedplate 5.

A spiral disk 10 is accommodated with its cylindrical base 38 in a circular opening 47 of the intermediate piece 4. On its side lying opposite the base 38, it has a spiral bar 36 which rests against projections 37 of the bedplate 5. Through turning of the spiral disk 10, the intermediate piece 4 together with the intermediate piece 40 and the hinge arm 7 is shifted in the direction of the height of the item of furniture.

The adjustment of the hinge arm 7 in the direction of the depth of the item of furniture again takes place by means of an eccentric 29 which is housed in the intermediate piece 40. The eccentric cam 30 of the eccentric 29 is accommodated in an oblong hole 31 of the hinge arm 7.

The joint-adjustment screw 24 is housed in a nut thread 59 of the intermediate piece 40 and is anchored with its head 26 in a stirrup 60 of the intermediate piece 4.

Through turning of the joint-adjustment screw 24, the intermediate piece 40 together with the hinge arm 7 is tilted relative to the intermediate piece 4 and to the bedplate 5 about the axle formed by the pin 22.

In order that, during the joint adjustment of the intermediate piece 40 and of the hinge arm 7, the position of the hinge axle is not changed in the direction of the depth of the item of furniture, the intermediate piece 4 has grooves 61, running diagonally in its side bars 4′, in which journals 62 housed in side bars 40′ of the intermediate piece 40 engage. Through the diagonal guide of the grooves 61 and the journals 62, upon turning of the adjustment screw 24 the intermediate piece 40 together with the hinge arm 7 is simultaneously shifted in the direction of the depth of the item of furniture, as a result of which the swivelling of the hinge axis relative to the depth of the item of furniture is again balanced out.

1. Hinge for furniture with a frame and with a door wing secured to the frame, with a bedplate which is to be fitted to the frame and which carries a hinge arm, and with a joint-adjustment screw, characterized by a diagonal guide for the hinge arm, via which the latter is also shifted in the direction of the depth of the item of furniture upon turning of the joint-adjustment screw relative to the bedplate.

2. Hinge according to claim 1, characterized in that the diagonal guide is formed by grooves in side bars of the bedplate, into which guide journals of the hinge arm project.

3. Hinge according to claim 1, characterized in that the diagonal guide is formed by slits in side bars of the bedplate, into which guide journals of the hinge arm project.

4. Hinge according to claim 2, characterized in that at least one intermediate piece, at which the grooves are developed, is arranged between the bedplate and the hinge arm.

5. Hinge according to claim 3, characterized in that at least one intermediate piece, at which the slits are developed, is arranged between the bedplate and the hinge arm.

6. Hinge according to claim 1, characterized in that an intermediate piece, at which guide journals are provided which project into grooves in the bedplate, is arranged between the bedplate and the hinge arm.

7. Hinge according to claim 1, characterized in that an intermediate piece, at which guide journals are provided which project into slits in the bedplate, is arranged between the bedplate and the hinge arm.

8. Hinge according to claim 1, characterized in that an intermediate piece, at which guide journals are provided which project into grooves in the bedplate, is arranged between the bedplate and the hinge arm.

9. Hinge according to claim 1, characterized in that an intermediate piece, at which guide journals are provided which project into slits in the hinge arm, is arranged between the bedplate and the hinge arm.

10. Hinge according to claim 1, characterized in that two intermediate pieces are arranged between the hinge arm and the bedplate and the diagonal guide is developed between these two intermediate pieces.

11. Hinge according to claim 10, characterized in that the two intermediate pieces have overlapping side bars, the grooves or slits being provided in the side bars of one intermediate piece and the guide journals at the side bars of the second intermediate piece.

12. Hinge according to claim 10, characterized in that one intermediate piece and the hinge arm have oblong holes through which a pin projects which connects the hinge arm, the two intermediate pieces and the bedplate to each other.

13. Hinge according to claim 12, characterized in that the oblong holes in the intermediate piece are open oblong holes.
